(19) United States
(12) Patent Application Publication
(10) Pub. No.: US 2007/0174039 A1
(43) Pub. Date: Jul. 26, 2007

(54) Method of automatically analyzing claims in patents

(76) Inventors: Shengfu Lin, Taipei (TW); Shih Hung Lin, Taipei (TW)

Correspondence Address: BACON & THOMAS, PLLC, 625 SLATERS LANE, FOURTH FLOOR, ALEXANDRIA, VA, 22314, US

(21) Appl. No.: 11/653,997

(22) Filed: Jan. 17, 2007

Related U.S. Application Data
(60) Provisional application No. 60/759,038, filed on Jan. 17, 2006.

(51) Int. Cl. G06F 17/20

(52) U.S. Cl. 704/1

(57) ABSTRACT

A method of automatically analyzing claims includes: a separating structure step for finding a transition phrase within the claims, defining text before the transition phrase as a preamble and text after the transition phrase as a body; a separating elements step for separating one or a plurality of elements and/or characteristics from the body according to paragraphing and/or specific punctuation; and a data processing step for processing the results from the separating structure step and/or the separating elements step and creating a file or files, wherein all of the above steps are executed automatically in a computer.

### BACKGROUND OF THE INVENTION

1. Field of the Invention

The present invention relates to a method of automatically analyzing claims in patents and, more particularly, to a method of automatically analyzing claims in patents by a computer.

2. Description of the Related Art

In patent specifications, claims are the primary section for defining the patent subject matter. However, due to their specific structure and writing styles, most of people are unable to readily understand claims. There are books that discuss claims, such as, “Mechanics of Patent Claim Drafting” by John L. Landis (published by Practising Law Institute, 1974, second version, ISBN 74-77345). But, there is still no technology that can be used for analyzing claims. The main problems include:

1. How to automatically divide complicated claims into individual single claims?

2. How to automatically divide individual single claims into independent claims or dependent claims.

3. How to automatically determine the dependency relationships between the dependent claims and the independent claims.

4. How to automatically parse out the preamble, the transition phrase and the body of the claim.

5. How to automatically extract from the claim every element in the body.

6. How to automatically record or file the results of the above problems 1 to 5.

For IT companies, if the results of problems 1 to 5 can be obtained, problem 6 can be solved, but without a knowledge of claim structure, problems 1 to 5 cannot be solved.

### SUMMARY OF THE INVENTION

An objective of the present invention is to provide a method of automatically analyzing claims in patents.

Another objective of the present invention is to provide a method of automatically analyzing claims in patents by a computer.

Another objective of the present invention is to provide a method of automatically analyzing independent claims.

Another objective of the present invention is to provide a method of automatically analyzing independent claims in patents by a computer.

Another objective of the present invention is to provide a method of automatically analyzing claims in patents with a step for separating patent structures, a step for separating patent elements, and a data processing step.

Another objective of the present invention is to provide a method of automatically analyzing dependent claims in patents.

Another objective of the present invention is to provide a method of automatically analyzing dependent claims in patents by a computer.

The method of the automatically analyzing claims in patents of the present invention comprises:
separating every individual claim by the numbering at the very beginning and the period at the end of the claim;
finding a transition phrase by reading every claim and extracting a preamble and a body from each claim;
determining whether the preamble of each claim includes a dependency clause:
if there is no such clause, then defining the claim as an independent claim;
if there is such a clause, then defining the claim as a dependent claim and using the dependency clause in the preamble of the dependent claim to determine the related dependent claim or/and independent claim of this dependent claim;
analyzing elements and/or characteristics in each claim; and
creating a file containing the analyzing step;

characterized in that each of the above steps is executed automatically.

The most common transition phrases are:

“comprise, comprises, comprised, comprising”;

“include, includes, included, including”;

“have, has, had, having”;

“consist of, consists of, consisted of, consisting of”;

“compose of, composes of, composed of, composing of”;

or certain other transition phrases, such as: “wherein”, “characterized in”, etc.

The above common transition phrases may be more verbose, as in “comprise the following steps of, comprises the following steps of, comprised the following steps of, comprising the following steps of”; “further comprise, further comprises, further comprised, further comprising”(which are often used in dependent claims), generally considered as derivative transition phrases of “comprises”; and “consist essentially of, consists essentially of, consisted essentially of, consisting essentially of”, which are generally considered derivative transition phrases of “consisted of”. The transition phrase in the present invention can be transition phrases (such as “comprises”) or derivative transition phrases (such as “comprising the following steps of”).

The transition phrases can be listed out and provided by experienced patent drafters, and statistical and analytical methods (such as text mining methods) may be utilized to list other transition phrases, or to build a transition phrase database having all transition phrases (used as an assistant database), or to build a derivative transition phrase database and a non-derivative transition phrase database (used as an assistant database). Alternatively, statistical and analytical methods may be utilized to list all transition phrases; however, errors may be introduced dues to a lack of sufficient experimental data, so that common means clauses or functional clauses in claims may be construed as transition phrases. Furthermore, there exist other transition phrase identification methods, such as punctuation analysis methods, paragraphing analysis methods, etc. For example, many claims in patents use specific punctuation forms (such as “:”) after the transition phrase, and/or may employ a new paragraph.

With complete or substantially complete transition phrase information and/or databases and the associated transition phrase identification methods, the transition phrase can be found in the claims. The text before the transition phrase may then be defined as a preamble, and the text after the transition phrase may be defined as the body of the claim. However, in some very rear situations, a prepositional phrase of the transition phrase lies between the transition phrase and the preamble. In these situations, the prepositional phrase should be excluded from the preamble. Common prepositional phrases are “which”, “said method”, “said device”, etc. In some other very rare situations, an inversion of the transition phrase lies between the transition phrase and the body, and the inversion should be placed after the preamble for consideration as a portion of the preamble; the text after the inversion may be defined as the body. If necessary, an inversion data base may be provided for automatic analyses. The inversions may include, for example, “prior to . . . (step)”.

The step of separating every element in every claim is different for independent claims and dependent claims, as explained in the following disclosure.

Common dependency clauses include, for example, “as claimed in . . . claim (one or multiple numbers)”, “according to claim . . . (number) to . . . (number) ”, etc. Alternatively, a dependency clause database may be provided as an assistant database.

The automatic method may be performed by any software, firmware or hardware method to replace the prior manual method. For example, a PDA and/or computer can be utilized to execute the steps (which is the preferred embodiment), or a specifically designed device or apparatus may be utilized to execute the steps. The automatically executed steps can be part of a complete automatic process, or part of a core automatic process. For example, if the computer finds “comprising . . . :” in the claims and the content between “comprising” and “:” is not a known derivative or inversion, it may require manual determination for whether it is a derivative or inversion phrase, and may add this new derivative or inversion to the assistant database for further analyses.

The following symbolic claims (from claim 1 to 3) are used as an example for the following explanation:
1. A(n) AAA comprising:

a(n) AA . . . ;

a(n) BB . . . ; and

a(n) CC . . .

(symbolic claim 1)
2. The AAA as claimed in claim 1, wherein the AA . . .

(symbolic claim 2)
3. The AAA as claimed in claim 1 or 2, wherein the BB . . .

(symbolic claim 3)

The automatic analysis software has a flowchart as shown in FIG. 1:
(A) separating every claim—the computer reads from “A(n) AAA comprising:” to the first period “.” and determines the following contents are claim 1. Since the first character after the period is “2”, the above determination is correct (the ensured result is highlighted hereinafter):

“A(n) AAA, comprising:

a(n) AA, ...;

a(n) BB, ...; and

a(n) CC, ...”
(B) identifying the status of claims—based upon the “comprising” in the first paragraph:

preamble: A(n) AAA

this claim is an independent claim (because the preamble does not include a dependency clause)

the patent subject matter: AAA

claim status: open ended.
(C) performing a determination process—an independent claim determination process is performed according to the above results.
(D) analyzing the independent claim—analysis is performed as indicated by the flowchart shown in FIG. 2, building a result files, which is explained in steps (D-1) to (D-4).

Step (A) of separating every claim, and step (B) of identifying the status of the claims are repeated to analyze the claims after claim 1:
(A) separating each claim—the computer reads from “2. The AAA as claimed in claim 1, wherein” to the next period “.” and determines the following content indicated below is claim 2. Since the first character after the period is “3”, the above determination is correct:

“2. The A AAas claimed in claim 1, wherein AA . . . ”
(B) identifying the status of claims—determining from “wherein . . . ”

preamble: The AAA as claimed in claim 1

this claim is a dependent claim of claim 1, because the preamble has the dependency clause “as claimed in claim 1”.

the patent subject matter: AAA

claims status: open ended.
(C) performing a determination process—a dependent claim determination process is performed according to the above results.
(E)/(F) analyzing the dependent claim—analysis is performed as indicated by the flowchart shown in FIG. 3, thereby building a result file, which is explained in (E-1) to (E-8); or analysis is performed as indicated by the flowchart shown in FIG. 4, building a result file, which is explained in (F-1) to (F-8).

Step (A) of separating every claim, and step (B) of identifying the status of the claims are repeated to analyze the claims after claim 2:
(A) separating each claim—the computer reads from “3. The AAA as claimed in claim 1 or 2, wherein the BB”, to the first period “.” and determines the following content indicated below is claim 3. Since the beginning of the sentence is “3” and there is no content after the period, the above determination is correct:

“The AAA as claimed in claim 1 or 2, wherein the BB . . . ”
(B) identifying the status of claims—determining from “wherein . . . ”

preamble: The AAA as claimed in claim 1

this claim is a dependent claim of claim 1 or 2, because the preamble has the dependency clause “The AAA as claimed in claim 1 or 2”.

the patent subject matter: AAA

claim status: open ended.
(C) performing a determination process—a dependent claim determination process is performed according to the above result.
(E)/(F) analyzing the dependent claim—analysis is performed as indicated in the flowchart shown in FIG. 3, and the building of the result file, which is explained in (E-1) to (E-8); or the analysis as indicated in the flowchart shown in FIG. 4 is performed to build the result file, which is explained in (F-1) to (F-8).

For independent claims, the automatic analysis method of the present invention comprises:

a separating structure step for finding a transition phrase within the independent claims, and essentially defining the text before the transition phrase as a preamble and the text after the transition phrase as a body of the claim;

a separating elements step for separating one or a plurality of elements and/or characteristics from the body according to paragraphing and/or specific punctuation; and

a data processing step for processing the results from separating structure step and/or the separating elements step and creating a resultant file or files;

characterized in that all of the above steps are executed automatically.

The separating structure step searches for the transition phrase and uses it to identify the preamble, the transition phrase, and the body. Some common transition phrases are defined in the above-mentioned description.

The separating structure step can also determine the status of the claims according to the transition phrase; for example, the transition phrase can be “comprising”, “including”, “having” or their derivative transition phrases, which can be used for determining that the status of the claim is open ended; or the transition phrase may be “consisting of . . . ,” “composed of . . . ” or their derivative transition phrases, which can be used for determining that the status of the claim is closed ended.

The preamble can be just descriptive of the patent subject matter, but some complicated preambles may have not just the patent subject matter but also functional clauses and/or structural clauses. For complicated preambles, further identification methods for the patent subject matter, the functional clauses and/or the structural clauses may be required. However, the identification method for complicated preambles is not the point of the present invention, so no further description will be provided.

The separating elements step utilizes the paragraphing and/or specific punctuation (such as semicolon “;”) to separate the body into elements and/or characteristics. Generally, Jepson type claims include prior art portion and improvement portion (or called characteristics portion), wherein the prior art portion has one or a plurality of elements, the improvement portion has one or a plurality of elements. But non-Jepson type claims only includes one or a plurality of elements. In either Jepson type claims or non-Jepson type claims, their elements are usually separated by paragraphing and/or specific punctuation formatting (such as “;”); therefore, the paragraphing process and/or specific punctuation can be used as the reference for separating every element. Some assistant identification methods for elements can be utilized; for example, “and” often exists between the last element and the second-to-last element, which can be used as an identification reference for the separating elements step.

The paragraphing process is base on indents and/or line changes, and line changes are more common.

Taking U.S. patents in 2002 as examples, in approximately 70% of patents the paragraphing process and semicolon can be used as a separating elements reference; and in approximately 10% of patents, the paragraphing process (usually working with “,”, such as in U.S. Pat. No. 6,334,356) can be used as a separating elements reference. In approximately 3% of patents, semicolon can be used as a separating elements reference (such as in U.S. Pat. No. 6,334,294), and in approximately 17% of patents the paragraphing process and/or specific punctuation cannot be used as separating elements references. However, the numbering marks, such as (1), (2), (3), . . . or (a), (b), (c), . . . can reduce this 17% to below 15%. Therefore, the above mentioned methods can automatically analyze about 83% to 85% of the claims in U.S. patents.

The data processing step is used for building files containing information about the preamble, transition phrase and each element/characteristic obtained by the separating structure step and the separating elements step. The files may include temporary files (which may be used for storing temporary data) or short/middle/long period files. The content in the file can be determined by user requirements, such as: independent claim numbering data, dependent claim numbering data, dependent relationships of independent claims/dependent claims, the patent subject matter of every claim, every independent claim element, the status of every claim, every independent claim characteristic, every dependent claim dependent element, every dependent claim dependent characteristic, a table of the patent subject matter, and/or a table of the elements, etc. Of course, additional data may be provided; for example, a claim chart for infringement analsis. The format of the file is not limited and can be customized.

According to the above analysis, claim 1 is an independent claim, and the automatic analysis software can perform the flowchart shown in FIG. 2:
(D-1) finding the transition phrase—referring to step (B)
(D-2) defining the preamble/body: since the transition phrase does not include a derivative phrase or an inversion phrase, the text after the transition phrase is the body, and the text before the transition phrase is the preamble.
(D-3) the independent claim analysis mechanism in the the computer can automatically determine that this independent claim comprises three elements according to the paragraph and semicolons:

“a(n) AA . . . ” (the first element)

“a(n) BB . . . ;” (the second element)

“a(n) CC . . . ” (the third element)
(D-4) the computer builds files for the analysis result of claim 1.

For dependent claims, a first automatic analysis method of the present invention comprises:

a separating structure step for finding a transition phrase in phrase the dependent claims, and essentially defining the text before the transition phrase as a preamble and the text after the transition phrase as a dependent body;

finding a dependency clause to determine the related dependent claims and/or independent claims of the dependent claim;

a separating elements step for separating one or a plurality of dependent elements and/or dependent characteristics from the dependent body according to paragraphing and/or specific punctuation;

adding one or the plurality of dependent elements and/or dependent characteristics to the related dependent claims and/or independent claims and considering the resultant claims as new claims; and

analyzing the new independent claims according to the independent claim automatic analysis method;

characterized in that all of the above steps are executed automatically.

When the plurality of dependent elements and/or dependent characteristics are added into the related dependent claims and/or independent claims, the periods at the end of the dependent claims and/or independent claims should be changed into semicolon.

The dependent body, dependent elements or dependent characteristics, and the above mentioned body, elements and characteristics are not very different from each other; “dependent” is used to indicate the dependent body, dependent elements or dependent characteristics are defined by a dependent claim.

According to the above analysis, claim 2 is a dependent claim; the automatic analysis software can perform the flowchart shown in FIG. 3:

(E-1) finding the transition phrase—referring to step (B).

(E-2) defining the preamble/body—referring to step (B).

(E-3) verifying the dependent claim antecedent numbering—according to the dependency clause, the dependent claim antecedent number is 1.

(E-4) performing a determination process—according to the above result, it is determined that the dependent claim is single, and the method directly jumps to step (E-6).

(E-6) adjusting the independent claim—adding the dependent element (the body) in claim 2 into claim 1 to generate a new claim as follows:
“A(n) AAA, comprising;
   a(n) AA, . . . ;
   a(n) BB, . . . ; and
   a(n) CC, . . . ,
Wherein the AA . . . ”

(E-7) analyzing the claim—generating a new claim, according to the independent claim analysis mechanism (referring to step (D-1) to (D-3)), according the positions of the paragraph and semicolons:
the patent subject matter: AAA
claims status: open ended
this claim comprises not just the first element, the second element and the third element but also the fourth element:
   “wherein the AA . . . ” (the fourth element)

(E-8) the computer builds files for the analysis result of claim 2. Similarly, according to the above analysis, claim 3 is a dependent claim; the automatic analysis software can perform the flowchart shown in FIG. 3:

(E-1) finding the transition phrase—referring to step (B).

(E-2) finding the preamble/body—referring to step (B).

(E-3) verifying the dependent claim antecedent numbering—based upon the dependency clause, the dependent claim antecedent number is 1 or 2.

(E-4) performing a determination process—according to the above results, the plurality of dependent claims may be determined and then the process continues to step (E-5).

(E-5) automatically separating the content in claim 3 into a claim 3-1 that is dependent on claim 1, and a claim 3-2 that is dependent on claim 2 (because the dependency clause “as claimed in claim 1 or 2” indicates that claim 3 separately depends on claim 1 and claim 2).

(E-6) adjusting the contents of claim 3-1 into an independent claim format
the dependent elements (the body) are added into the end of claim 1 to generate a new claim:
“(n) AAA, comprising:
   a(n) AA, . . . ;
   a(n) BB, . . . ; and
   a(n) CC, . . . ;
wherein the BB . . . ”
the contents of claim 3-2—the dependent elements (the body) are added into the end of claim 2 to generate a new claim:
“A(n) AAA, comprising:
   a(n) AA . . . ;
   a(n) BB, . . . ; and
   a(n) CC, . . . ;
wherein the AA . . . ;
wherein the BB . . . ”

(E-7) analyzing claim—a new claim analysis is generated according to the independent claim analysis mechanism (referring to steps (D-1) to (D-3)):
claim 3-1:
   the patent subject matter: AAA
   claim status: open ended
   this claim comprises not just the first element, the second element and the third element but also the fourth element:
      “wherein the AA . . . ”(the fourth element)
claim 3-2:
   patent subject matter: AAA
   claim status: open ended
   this claim comprises not just the first element, the second element, the third element and the fourth element but also the fifth element:
      “wherein the BB . . . ” (the fifth element)

(E-8) the computer builds files for the analysis results of claim 3 (including claim 3-1 and claim 3-2).

For dependent claims, a second automatic analysis method of the present invention comprises:
a separating structure step for finding a transition phrase phrase and essentially defining the text before the transition phrase as a preamble and the text after the transition phrase as a dependent body;
finding a dependency clause to determine the related dependent claims and/or independent claims for the dependent claim;
a separating elements step for separating one or a plurality of dependent elements and/or dependent characteristics from the dependent body according to paragraphing and/or specific punctuation;
adding one or the plurality of dependent elements and/or dependent characteristics to the related dependent claims and/or independent claims and considering the resultant claims as new claims; and
a data processing step for processing the results from the above steps and creating related files
characterized in in that all of the above steps are executed automatically.

According to the above analysis, claim 2 is a dependent claim, and the automatic analysis software may perform the flowchart shown in FIG. 4:
(F-1) finding the transition phrase—referring to step (B).
(F-2) defining a preamble/body—referring to step (B).
(F-3) verifying the dependent claim antecedent numbering—based upon the dependency clause, the dependent claim antecedent number is 1.
(F-4) performing a determination process—according to the above results, the claim is determined to be singly dependent, and the method jumps directly to step (F-6).
(F-6) analyzing the new elements—determining elements based upon the body:

“wherein the AA . . . ”
(F-7) adding the new element or elements into the elements of the dependent claim and automatically determining that:

the patent subject matter is AAA;

the claim status is open ended;

this claim comprises not just the first element, the second element and the third element but also the fourth element:
the AA . . . (the fourth element)
(F-8) the computer builds files for the analysis results of claim 2.

Similarly, according to the above analysis, claim 3 is a dependent claim, and so the automatic analysis software may perform the flowchart shown in FIG. 4:
(F-1) finding the transition phrase—referring to step (B).
(F-2) defining a preamble/body—referring to step (B).
(F-3) verifying the dependent claim antecedent numbering—based upon the dependency clause, the dependent claim number is 1 or 2.
(F-4) performing a determination process—according to the above results, the dependent claim is determined to be multiple dependent, and then step (F-5) is performed.
(F-5) automatically separating the content in claim 4 into claim 3-1 that is dependent on claim 1, and claim 3-2 that is dependent on claim 2 (because the dependency clause “as claimed in claim 1 or 2” indicates claim 3 may depend from claim 1 or claim 2).
(F-6) analyzing the new elements—determining elements base on the body:

“wherein the BB . . . ”
(F-7) adding the new element into the element of the dependent claim to automatically determine:

claim 3-1:

comprising not just the first element, the second element and the third element but also the sixth element:
“the BB . . . ” (the sixth element)

claim 3-2:

comprising not just the first element, the second element, the third element and the fourth element but also the sixth element.
(E-8) the computer builds files for the analysis results of claims 3-1 and 3-2.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a preferred embodiment for claims analysis according to the present invention.

FIG. 2 is a flowchart drawing of a preferred embodiment of independent claims analysis according to the present invention.

FIG. 3 is a flowchart drawing of a preferred embodiment of a dependent claims analysis according to the present invention.

FIG. 4 is a flowchart drawing of another preferred embodiment of dependent claims analysis according to the present invention.

### DETAILED DESCRIPTION OF THE PREFERRED EMBODIMENT

### The First Embodiment

The claims of Taiwan utility patent No. 237,648 (serial number 81217783, which is a counter-part of U.S. Pat. No 5,352,226) is input into a computer. The relevant contents are presented in the following:
“1.A side locking system for use in spinal surgery comprising:

a side locking member including a side locking block and a rotatable locking block, said side locking block having a through hole receiving a spinal locking rod and having a fastening slit substantially perpendicular to an axis of said through hole that extends to said rotatable locking block, said rotatable locking block having a rotatable receiving mount of a spherical construction;

a spherical liner mounted in said rotatable locking block and provided with a hollow portion so dimensioned as to receive a spinal pin, said spherical liner further having a slit; and

means for tightening said fastening slit of said side locking block so as to bring about a compression of said spherical liner, which in turn causes said through hole of said side locking block to clamp said spinal locking rod.
2. The side locking system as claimed in claim 1, wherein said fastening slit of said side locking block is a through slit.
3. The side locking system as claimed in claim 1, wherein said fastening slit of said side locking block is a non-through slit.
4. The side locking system as claimed in any one of claim 1 to 3, wherein said rotatable locking block and said spherical liner can be rotated, relative to each other, in all directions.
5. The side locking system as claimed in any one of claim 1 to 3, wherein said slit of said spherical liner is oriented obliquely with respect to an axis defined by said hollow portion.
6. The side locking system as claimed in claim 4 wherein said slit of said spherical liner is oriented obliquely with respect to an axis defined by said hollow portion.”

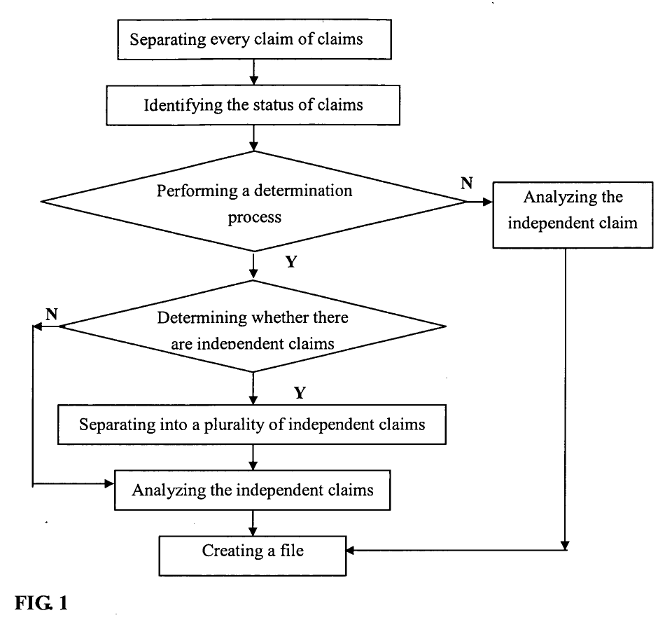

The automatic analysis software performs the steps indicated in the flowchart shown in FIG. 1:
(A) separating every claim—the computer reads from “1. A side locking system for use in spinal surgery, comprising:” to the first period “.”and determines that the following content is claim 1. Since the first character after the period is “2”, the above determination is correct.
“1. A side locking system for use in spinal surgery comprising:

a side locking member including a side locking block and a rotatable locking block, said side locking block having a through hole receiving a spinal locking rod and having a fastening slit substantially perpendicular to an axis of said through hole that extends to said rotatable locking block, said rotatable locking block having a rotatable receiving mount of a spherical construction;

a spinal pin adapted to be fastened within a vertebra;

a spherical liner mounted in said rotatable locking block and provided with a hollow portion so dimensioned as to receive the spinal pin, said spherical liner further having a slit; and

means for tightening said fastening slit of said side block so as to bring about a compression of said spherical liner in order to clamp said spinal pin, which in turn causes through hole of said side locking block to clamp said spinal locking rod.”
(B) identifying the status of the claims—based upon the “comprising” in the first paragraph:

preamble: A side locking system for use in spinal surgery this claim is an independent claim (because the preamble does not include a dependency clause)

the patent subject matter: a side locking system for use in spinal surgery

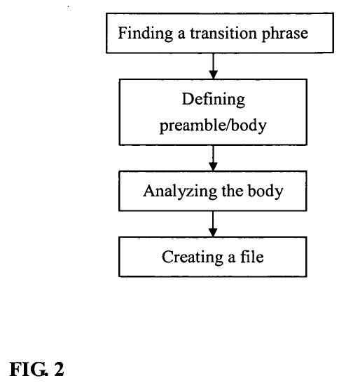

claim status: open ended.
(C) performing a determination process—an independent claim determination process is performed according to the above results.
(D) analyzing the independent claim—analyzing according to the flowchart shown in FIG. 2:

(D-1) finding the transition phrase—referring to step (B)

(D-2) defining a preamble/body: the transition phrase does not include derivative phrases or inversion phrases; the text after the transition phrase is the body, and the text before the transition phrase is the preamble.

(D-3) the independent claim analysis mechanism in the computer can automatically determine that this independent claim comprises three elements according to the positions of the paragraphs and semicolons:
“side locking member including a side locking block and a rotatable locking block, said side locking block having a through hole receiving a spinal locking rod and having a fastening slit substantially perpendicular to an axis of said through hole that extends to said rotatable locking block, said rotatable locking block having a rotatable receiving mount of a spherical construction;”
   (the first element)
“a spherical liner mounted in said rotatable locking block and provided with a hollow portion so dimensioned as to receive a spinal pin, said spherical liner further having a slit;”
   (the second element)
“means for tightening said fastening slit of said side locking block so as to bring about a compression of said spherical liner in order to clamp said spinal pin, which in turn causes said through hole of said side locking block to clamp said spinal locking rod.”
   (the third element)
(D-4) the computer builds files for the analysis results of claim 1.

Step (A) separating each claim and step (B) identifying the status of claims are repeated to analyze claims after claim 1:
(A) separating each claim—the computer reads from “2. The side locking system for use in spinal surgery as claimed in claim 1, wherein” to the next period “.”. Since the first character after the period is “3”, the above determination is correct:

“2. The side locking system as claimed in claim 1 wherein said fastening slit of said side locking block is a through slit.”
(B) identifying the status of the claims—based upon the phrase “wherein . . . ”

preamble: The side locking system as claimed in claim 1 this claim is a dependent claim of claim 1, because the preamble has the dependency clause, “The AAA as claimed in claim 1”.

the patent subject matter: a side locking system for use in spinal surgery

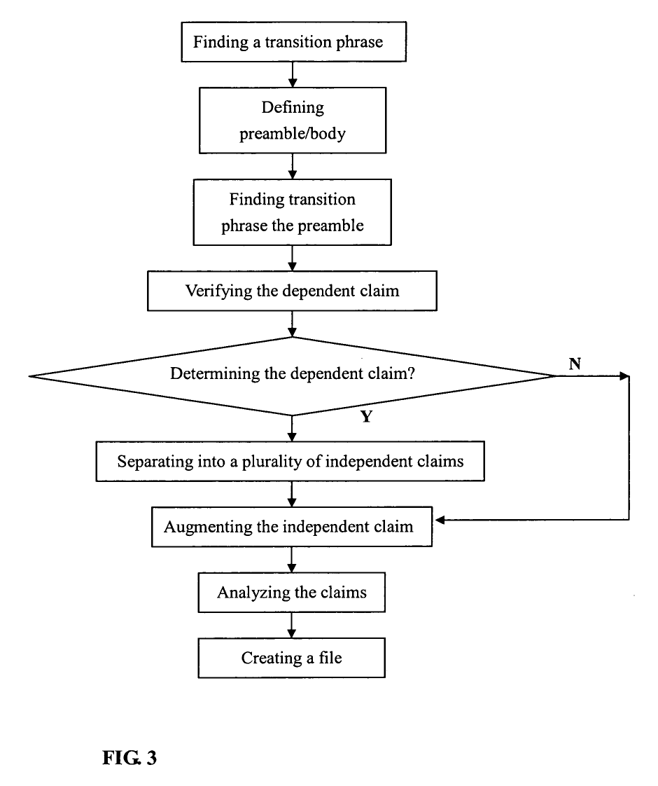

claim status: open ended.
(C) performing a determination process—an dependent claim determination process is performed based upon the above results.
(E) analyzing the dependent claim—an analysis according to the flowchart shown in FIG. 3 is performed:
(E-1) finding the transition phrase—referring to step (B).
(E-2) extracting the preamble/body—referring to step (B).
(E-3) verifying the dependent claim antecedent numbering—based upon the dependency clause, the dependent claim antecedent number is 1.
(E-4) performing a determination process—according to the above results, the dependent claim is determined to be singly dependent, and the process jumps directly to step (E-6).
(E-6) augmenting the independent claim—the dependent element (the body) in claim 2 is added into claim 1 to generate a new claim as follows:

“2. A side locking system for use in spinal surgery comprising:
a side locking member including a side locking-block and a rotatable locking block, said side locking block having a through hole receiving a spinal locking rod and having a fastening slit substantially perpendicular to an axis of said through hole that extends to said rotatable locking block, said rotatable locking block having a rotatable receiving mount of a spherical construction;
a spherical liner mounted in said rotatable locking block and provided with a hollow portion so dimensioned as to receive a spinal pin, said spherical liner further having a slit; and
means for tightening said fastening slit of said side locking block so as to bring about a compression of said spherical liner in order to clamp said spinal pin, which in turn causes said through hole of said side locking block to clamp said spinal locking rod; and

means for tightening said fastening slit of said side locking block so as to bring about a compression of said spherical liner in order to clamp said spinal pin, which in turn causes said through hole of said side locking block to clamp said spinal locking rod,

wherein said fastening slit of said side locking block is a through slit.”
(E-7) analyzing the claim—a new claim analysis is performed, utilizing the independent claim analysis mechanism (with reference to steps (D-1) to (D-3)), based upon the positions of the paragraphs and semicolons:

the patent subject matter: a side locking system for use in spinal surgery

claim status: open ended;

this claim comprises not just the first element, the second element and the third element but also the fourth element:
“said fastening slit of said side locking block is a through slit” (the fourth element)
(E-8) the computer builds files for the analysis results of claim 2.

Similarly, according to the above analysis, claim 3 can be analyzed as follows:

the patent subject matter: a side locking system for use in spinal surgery

the status of this claim: open ended

this claim has not only the first element, the second element and the third element, but also the fifth element:

“said fastening slit of said side locking block is a non-through slit” (the fifth element)

The computer then builds files for the analysis results of claim 3.

Step (A) separating each claim, and step (B) of identifying the status of the claims are repeated to analyze claim 4:

The computer automatically divides the contents of claim 4 into claim 4-1 that depends from claim 1, claim 4-2 that depends from claim 2, and claim 4-3 that depends from claim 3 (because the dependency clause “as claimed in any one of claim 1 to 3” indicates that claim 4 separately depends from claim 1, claim 2 and claim 3), and adjusts their contents as follows:
(E) analyzing the dependent claim—an analysis according to the following flowchart shown in FIG. 3 is performed:

(E-1) finding the transition phrase—with reference to step (B).

(E-2) extracting the preamble/body—with reference to step (B).

(E-3) verifying the dependent claim antecedent numbering-based upon the dependency clause, the dependent claim antecedent numbers are 1, 2, and 3.

(E-4) performing a determination process—according to the above results, a plurality of dependent claims are determined to result, and step (E-5) is then performed.

(E-5) The computer automatically divides the contents in claim 4 into a claim 4-1 that depends on claim 1, a claim 4-2 that depends on claim 2, and a claim 4-3 that depends on claim 3 (because the dependency clause “as claimed in any one of claim 1 to 3” indicates that claim 4 separately depends on claim 1, claim 2 and claim 3).

(E-6) augmenting the claims into independent claim from—the dependent element (the body) in claim 4 is added onto the ends of claims 1, 2, and 3 to generate new claims 4-1, 4-2, 4-3, as indicated in the following:
the contents of claim 4-1:
“4-1. A side locking system for use in spinal surgery comprising: a spinal locking rod;
a side locking member including a side locking block and a rotatable locking block, said side locking block having a through hole receiving the spinal locking rod and having a fastening slit substantially perpendicular to an axis of said through hole that extends to said rotatable locking block, said rotatable locking block having a rotatable receiving mount of a spherical construction;
a spinal pin adapted to be fastened within a vertebra;
a spherical liner mounted in said rotatable locking block and provided with a hollow portion so dimensioned as to receive the spinal pin, said spherical liner further having a slit; and
means for tightening said fastening slit of said side locking block so as to bring about a compression of said spherical liner in order to clamp said spinal pin, which in turn causes said through hole of said side locking block to clamp said spinal locking rod;
wherein the said rotatable locking block and said spherical liner can be rotated, relative to each other, in all directions.”
the contents of claim 4-2:
“4-2. A side locking system for use in spinal surgery comprising: a spinal locking rod;
a side locking member including a side locking block and a rotatable locking block, said side locking block having a through hole receiving the spinal locking rod and having a fastening slit substantially perpendicular to an axis of said through hole that extends to said rotatable locking block, said rotatable locking block having a rotatable receiving mount of a spherical construction;
a spinal pin adapted to be fastened within a vertebra;
a spherical liner mounted in said rotatable locking block and provided with a hollow portion so dimensioned as to receive the spinal pin, said spherical liner further having a slit; and
means for tightening said fastening slit of said side locking block so as to bring about a compression of said spherical liner in order to clamp said spinal pin, which in turn causes said through hole of said side locking block to clamp said spinal locking rod;
wherein said fastening slit of said side locking block is a through slit;
wherein the said rotatable locking block and said spherical liner can be rotated, relative to each other, in all directions.”
the contents of claim 4-3:
“4-3. A side locking system for use in spinal surgery comprising:
a spinal locking rod;
a side locking member including a side locking block and a rotatable locking block, said side locking block having a through hole receiving the spinal locking rod and having a fastening slit substantially perpendicular to an axis of said through hole that extends to said rotatable locking block, said rotatable locking block having a rotatable receiving mount of a spherical construction;
a spinal pin adapted to be fastened within a vertebra;
a spherical liner mounted in said rotatable locking block and provided with a hollow portion so dimensioned as to receive the spinal pin, said spherical liner further having a slit; and
means for tightening said fastening slit of said side locking block so as to bring about a compression of said spherical liner in order to clamp said spinal pin, which in turn causes said through hole of said side locking block to clamp said spinal locking rod;

wherein the said fastening slit of said side locking block is a non-through slit;
wherein the said rotatable locking block and said spherical liner can be rotated, relative to each other, in all directions.”

(E-7) analyzing the claim—utilizing the independent claim analysis mechanism (referring to steps (D-1) to (D-3)), the newly generated claims 4-1, 4-2, 4-3 may be automatically determined by the positions of the paragraphs and semicolons:
claim 4-1 has not only the first element, the second element and the third element, but also the sixth element:
   “said fastening slit of said side locking block is a through slit.” (the sixth element)
claim 4-2 has not only the first element, the second element, the third element and the fourth element, but also the sixth element.
claim 4-3 has not only the first element, the second element, the third element and the fifth element, but also the sixth element.

(E-8) the computer builds files for the analytical results of claims 4-1, 4-2 and 4-3.

The computer automatically spreads the contents in the fifth claim into claim 5-1 that depends on claim 1, claim 5-2 that depends on claim 2, and claim 5-3 that depends on claim 3:
the patent subject matter for claim 5-1, claim 5-2, and claim 5-3 is, for each claim: a side locking system for use in spinal surgery, and the status of each of these claims is open ended.
claim 5-1 has not only the first element, the second element, and the third element, but also the seventh element:
   “wherein the said slit of said spherical liner is oriented obliquely with respect to an axis defined by said hollow portion” (the seventh element).
claim 5-2 has not only the first element, the second element, the third element, and the fourth element, but also the seventh element.
claim 5-3 has not only the first element, the second element, the third element, and the fifth element, but also the seventh element.

The computer builds files for the analytical results of claim 5.

The computer automatically spreads the contents in claim 6 into claim 6-1 that indirectly depends on claim 1 (directly depending on claim 4), claim 6-2 that indirectly depends on claim 2, and claim 6-3 that indirectly depends on claim 3:
the patent subject matter for each of claim 6-1, claim 6-2, and claim
   6-3 is: a side locking system for use in spinal surgery;
the status of all of the claims is open ended;
claim 6-1 has not only the first element, the second element, the third element and the sixth element, but also the seventh element:
   “wherein the said slit of said spherical liner is oriented obliquely with respect to an axis defined by said hollow portion” (the seventh element).
claim 6-2 has not only the first element, the second element, the third element, the fourth element and the sixth element, but also the seventh element.
claim 6-3 has not only the first element, the second element, the third element, the fifth element and the sixth element, but also the seventh element.

The computer builds files for the analytical result of claim 6.

According to the above automatic analysis, the patent subject matter of claim 1, claim 2, claim 3, claim 4-1, claim 4-2, claim 4-3, claim 5-1, claim 5-2, claim 5-3, claim 6-1, claim 6-2, and claim 6-3 are all: “a side locking system for use in spinal surgery”, the status of every claim is open ended, and the elements are as shown in table 1:

| | claim | | | | | | | | | | | |
|---|---|---|---|---|---|---|---|---|---|---|---|---|
| | 1 | 2 | 3 | 4-1 | 4-2 | 4-3 | 5-1 | 5-2 | 5-3 | 6-1 | 6-2 | 6-3 |
| a side locking | Y | Y | Y | Y | Y | Y | Y | Y | Y | Y | Y | Y |
| system for use | | | | | | | | | | | | |
| in spinal | | | | | | | | | | | | |
| surgery | | | | | | | | | | | | |
| (the first | Y | Y | Y | Y | Y | Y | Y | Y | Y | Y | Y | Y |
| element) | | | | | | | | | | | | |
| (the second | Y | Y | Y | Y | Y | Y | Y | Y | Y | Y | Y | Y |
| element) | | | | | | | | | | | | |
| (the third | Y | Y | Y | Y | Y | Y | Y | Y | Y | Y | Y | Y |
| element) | | | | | | | | | | | | |
| (the fourth | | Y | | | Y | | | Y | | | Y | |
| element) | | | | | | | | | | | | |
| (the fifth | | | Y | | | Y | | | Y | | | Y |
| element) | | | | | | | | | | | | |
| (the sixth | | | | Y | Y | Y | | | | Y | Y | Y |
| element) | | | | | | | | | | | | |
| (the seventh | | | | | | | Y | Y | Y | Y | Y | Y |
| element) | | | | | | | | | | | | |

*Y indicates inclusion of the element.

### The Second Embodiment

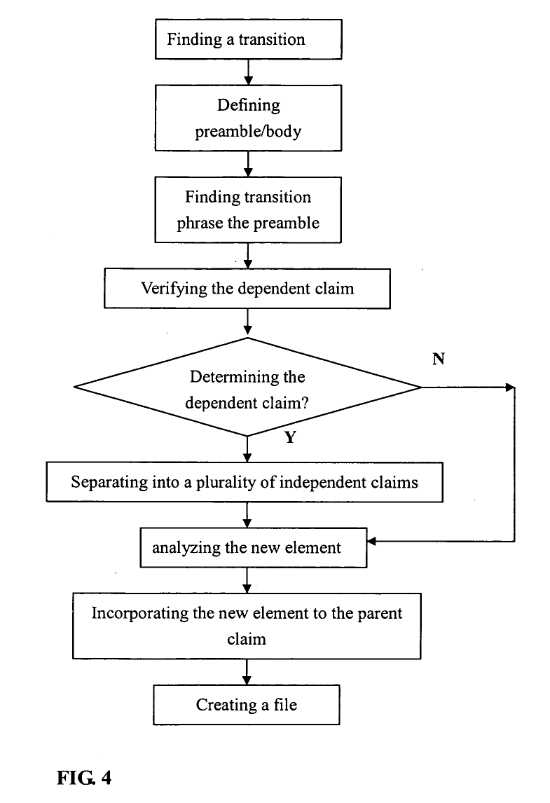

The second embodiment is similar to the first embodiment, but all dependent claims (claims 2, 3, 4, 5, 6) in the same patent are analyzed according to a second method of automatically analyzing dependent claims, as follows:
(F) analyzing the dependent claim—the method indicated in the flowchart of FIG. 4 is performed as follows:

(F-1) finding the transition phrase—referring to step (B).

(F-2) extracting the preamble/body—referring to step (B).

(F-3) verifying the dependent claim antecedent numbering—based upon the dependency clause, the dependent claim antecedent number is 1.

(F-4) performing a determination process—according to the above results, the dependent claim is determined to be singly dependent, and the method directly jumps to step (F-6).

(F-6) analyzing the new elements—determining new elements based upon the body as follows:
“wherein the said fastening slit of said side locking block is a through slit.”

(F-7) adding the new elements into the element of the dependent claim and automatically determining:
the patent subject matter: a side locking system for use in spinal surgery
claim status: open ended;
this claim comprises not just the first element, the second element and the third element, but also the fourth element:
   “said fastening slit of said side locking block is a through slit” (the fourth element).

(F-8) the computer builds files for the analytical results of claim 2.

The same method can analyze and determine claim 3 as follows:
the patent subject matter is: “a side locking system for use in spinal surgery”;
the status of this claim is open ended;
this claim has not only the first element, the second element and the third element, but also the fifth element:
   “said fastening slit of said side locking block is a non-through slit” (the fifth element).

The computer builds files for the analytical results of claim 3.

The computer automatically spreads the contents in claim 4 into claim 4-1 that depends from claim 1, claim 4-2 that depends from claim 2, and claim 4-3 that depends from claim 3 (because the dependency clause “as claimed in any one of claim 1 to 3” indicate that claim 4 separately depends on claim 1, claim 2 and claim 3) and separately augments their contents as follows:
(F) analyzing the dependent claim—the method indicated in the flowchart of FIG. 4 is performed as follows:

(F-1) finding the transition phrase—referring to step (B).

(F-2) defining preamble/body—referring to step (B).

(F-3) verifying the dependent claim antecedent numbering—based upon the dependency clause, the dependent claim antecedent numbers are 1, 2, and 3.

(F-4) performing a determination process—according to the above results, a plurality of dependent claims are determined to be analyzed, and the process continues with step (F-5).

(F-5) The computer automatically spreads the contents in claim 4 into claim 4-1 that depends on claim 1, claim 4-2 that depends on claim 2, and claim 4-3 that depends on claim 3 (because the dependency clause “as claimed in any one of claim 1 to 3” indicates that claim 4 may individually depends on claim 1, claim 2 or claim 3).

(F-6) analyzing the new elements—new elements from the body are determined as follows:
“wherein the said rotatable locking block and said spherical liner can be rotated, relative to each other, in all directions”

(F-7) adding the new elements into the element of the dependent claim and automatically determining that:
claim 4-1 comprises not only the first element, the second element and the third element, but also the sixth element:
   “said fastening slit of said side locking block is a through slit” (the sixth element);
claim 4-2 comprises not only the first element, the second element, the third element and the fourth element, but also the sixth element;
claim 4-3 comprises not only the first element, the second element, the third element and the fifth element, but also the sixth element.

(F-8) the computer builds files for the analytical results of claims 4-1, 4-2 and 4-3.

The computer automatically spreads the contents in claim 5 into claim 5-1 that depends on claim 1, claim 5-2 that depends on claim 2, and claim 5-3 that depends on claim 3.

The patent subject matter of each of claim 5-1, claim 5-2, and claim 5-3 is: “a side locking system for use in spinal surgery”; the status of each of the claims is open ended.

Claim 5-1 comprises not just the first element, the second element, and the third element, but also the seventh element:

“wherein the said slit of said spherical liner is oriented obliquely with respect to an axis defined by said hollow portion” (the seventh element).

Claim 5-2 comprises not just the first element, the second element, the third element, and the fourth element, but also the seventh element.

Claim 5-3 comprises not just the first element, the second element, the third element, and the fifth element, but also the seventh element.

The computer builds files for the analytical results of claim 5.

The computer automatically spreads the contents in the sixth claim into claim 6-1 that indirectly depends on claim 1 (directly depending from claim 4), claim 6-2 indirectly depends on claim 2, and claim 6-3 indirectly depends on claim 3.

The patent subject matter for each of claim 6-1, claim 6-2 and claim 6-3 is: “a side locking system for use in spinal surgery”, and the status of each-of these claims is open ended.

Claim 6-1 has not just the first element, the second element, the third element and the sixth element, but also the seventh element:
“wherein the said slit of said spherical liner is oriented obliquely with respect to an axis defined by said hollow portion”(the seventh element).

Claim 6-2 comprises not just the first element, the second element, the third element, the fourth element and the sixth element, but also the seventh element.

Claim 6-3 comprises not just the first element, the second element, the third element, the fifth element and the sixth element, but also the seventh element.

The computer builds files for the analytical result of claim 6.

According to the above analysis, the results of the second embodiment is completely identical with the results of the first embodiment.

Although the present invention has been explained in relation to its preferred embodiment, it is to be understood that many other possible modifications and variations can be made without departing from the spirit and scope of the invention as hereinafter claimed.

What is claimed is:

1. A method of automatically analyzing claims in patents comprising:
separating each individual claim by the numbering at the beginning and the period at the end;
finding a transition phrase by reading each claim and extracting a preamble and a body from each claim;
determining whether the preamble of each claim includes a dependency clause:
if there is no dependency clause, then determining that the claim is an independent claim,
if there is a dependency clause, then determining that the claim is a dependant claim and using the dependency clause in the preamble of the dependant claim to determine the related dependant claim or independent claim of the dependant claim;
analyzing elements and/or characteristics in each claim; and
creating a file containing results of the analyzing steps;
wherein every above step is executed automatically.

2. The method as claimed in claim 1, wherein the separating step further ensures the separation of the claims according to a subsequent numbering of the claims.

3. The method as claimed in claim 1, wherein the separating step is stopped by recognizing an end of the claims.

4. The method as claimed in claim 1, wherein the step of finding the transition phrase comprises determining whether the claim is open ended or closed ended based on the transition phrase.

5. The method as claimed in claim 1, wherein the step of determining further determines whether the dependent claim is dependent on one single independent claim or one single related dependent claim or is dependent on multiple independent claims and/or related dependent claims.

6. The method as claimed in claim 5, wherein the step of analyzing the elements and/or characteristics further comprises:
separating the body of the dependent claim into one or a plurality of dependent elements and/or dependent characteristics by paragraphing and/or specific punctuation in the dependent body;
adding said one or the plurality of dependent elements and/or dependent characteristics to the related dependent claims and/or independent claims and considering the resultant claims as new claims; and
separating the resultant new claims into one or a plurality of elements and/or characteristics according to paragraphing and/or specific punctuation.

7. The method as claimed in claim 1, wherein when the step of determining the dependency clause determines the claim is an independent claim, the step of analyzing the elements and/or characteristics comprises separating the body of the independent claim into one or a plurality of elements and/or characteristics according to paragraphing and/or specific punctuation.

8. The method as claimed in claim 1, which is performed by a computer.

9. A method of automatically analyzing an independent claim comprising:
a separating structure step for finding a transition phrase within the independent claim, defining text before the transition phrase as a preamble of the independent claim and text after the transition phrase as a body of the independent claim;
a separating elements step for separating the body into one or a plurality of elements and/or characteristics according to paragraphing and/or specific punctuation; and
a data processing step for processing the results from the separating structure step and/or the separating elements step and creating a file or files containing the processing results;
wherein all of the above steps are executed automatically.

10. The method as claimed in claim 9, wherein the separating elements step further comprises determining whether the independent claim is open ended or closed ended based upon the transition phrase.

11. The method as claimed in claim 9, wherein the separating elements step separates the body into one or a plurality of elements and/or characteristics according to paragraphing.

12. The method as claimed in claim 9, wherein the separating elements step separates the body into one or a plurality of elements and/or characteristics according to paragraphing and specific punctuation.

13. The method as claimed in claim 9, which is performed by a computer.

14. A method of automatically analyzing a dependent claim comprising:
a separating structure step for finding a transition phrase in the dependent claim and defining text before the transition phrase as a preamble and text after the transition phrase as a dependent body;
finding a dependency clause to determine the related dependent claim(s) and/or independent claim(s) for the dependent claim;
a separating elements step for separating the dependent body into one or a plurality of dependent elements and/or dependent characteristics according to paragraphing and/or specific punctuation;
adding said one or the plurality of dependent elements and/or dependent characteristics to the related dependent claim(s) and/or independent claim(s) and considering the resultant claims as new independent claims; and
analyzing the new independent claims according to a method defined in claim 9;
wherein all of the above steps are executed automatically.

15. The method as claimed in claim 14, wherein the separating elements step further comprises determining whether the dependent claim is open ended or closed ended based upon the transition phrase.

16. The method as claimed in claim 14, wherein the separating elements step separates the dependent body into one or a plurality of elements and/or characteristics according to paragraphing.

17. The method as claimed in claim 14, wherein the separating elements step separates the dependent body into one or a plurality of elements and/or characteristics according to paragraphing and specific punctuation.

18. The method as claimed in claim 14, which is performed by a computer.
